(19) United States
(12) Patent Application Publication
(10) Pub. No.: US 2004/0119278 A1
(43) Pub. Date: Jun. 24, 2004

(54) Kit and method for producing a perfect bound book

(76) Inventors: Kristin Olson VanDeWalle, Bozeman, MT (US); Harold F. Metzger JR., Elmhurst, IL (US)

Correspondence Address: MCHALE & SLAVIN, P.A., 2855 PGA BLVD, PALM BEACH GARDENS, FL, 33410, US

(21) Appl. No.: 10/323,271

(22) Filed: Dec. 18, 2002

(51) Int. Cl. B42D 1/00

(52) U.S. Cl. 281/21.1

(57) ABSTRACT

A kit for constructing a perfect bound book comprises a rigid book-like cover and a supply of sheets of paper sized to fit in the book-like cover which are adapted form use in the kit. The cover has a front cover panel and a rear cover panel and a spine there between wherein the spine has a length and the front cover panel and the rear cover panel are hingedly attached to the spine along the length. The spine includes a central elongated panel and adjoining hingedly connected left and right elongated panels wherein the spine is positionable between a flat configuration and a U-shaped configuration. The left and right elongated panels each have inside surfaces which include adhesive regions are covered with removable strips. Each of the sheets of paper has an adhesive region adjacent to the inside edge which is covered with a removable strip. Images can be printed on the plurality of sheets of paper, and the plurality of sheets of paper can be adhered to the left and right elongated panels of the spine and one another in a substantially coextensive configuration to form a perfect bound book The images can be printed by a printer coupled to a personal computer or by a color copier. A method of assembling the perfect bound book is also disclosed.

### FIELD OF THE INVENTION

This invention relates generally to the field of book construction, and more particularly to a novel do-it-yourself kit for producing a perfect bound book.

### BACKGROUND OF THE INVENTION

In book manufacturing, the term “perfect binding” refers to a process wherein a series of folded signatures are laid flatly one on top of another to form a spine or back, with the stacked signatures being subsequently glued together along the bound edge or secured together by stitching or staples. The stacked signatures are then glued into a cover. This procedure is widely used in the book manufacturing industry as it is faster and less expensive than side or spine sewing, and it can be used to manufacture books which are too thick for saddle stitching. The perfect bound book has an appearance largely identical to a book with a sewn binding.

To consumers, the look and feel of a hardcover bound book lends import to the contents. Since computer software now makes it possible for an individual to create material which is comparable in appearance to that produced by a professional publishing house, it is highly desirable to provide a do-it-yourself means by which an individual can create a perfect bound book from their own material. Therefore, a need remains in the art for a kit for producing a perfect bound book which is especially adapted for digital images printed on a paper medium, and which enables a customer to use their own personal computer, printer and software to create a perfect bound book.

### DESCRIPTION OF THE PRIOR ART

Kraynak, et al., U.S. Pat. No. 3,892,427, discloses a method of preparing a personalized hard covered book which has variable and non-variable printed copy which utilizes a computer to print at least the personalized portions of the text. Continuous form computer printing sheets are pre-printed with the non-variable text of a given book. Variable text, such as a child's name and other personalized information, can be custom printed on the sheets containing non-variable text.

Ross, U.S. Pat. No. 5,465,213, discloses a computer based book manufacturing, distributing and retailing system for high speed reproduction of a single copy of a book. The system is intended for direct consumer sales since the manufacturing of a selected book can take place at the retail location. The system includes a computer having a database of books stored in digital formal. The system includes a binder for binding the text pages and cover into a book.

The present invention is directed to a do-it-yourself kit for producing a perfect bound book from the consumer's own material. In the prior art, patents disclosing “custom” bound books are directed only to the commercial manufacturing process of the perfect bound book.

### SUMMARY OF THE INVENTION

It is an objective of the invention to provide a self-contained do-it-yourself kit for producing a perfect bound book from digital images printed by a user on sheets of paper adapted for use in the kit. The digital images can be printed using a standard computer printer, such as an ink jet printer, or a color copier.

It is another objective to provide a self-contained do-it-yourself kit for producing a perfect bound book utilizes ink-jet paper for optimal image quality.

It is still another objective to provide a self-contained do-it-yourself kit for producing a perfect bound book which allows a user to utilize publishing software and digital image editing software on a personal computer to create custom pages for the book.

It is a further objective of the invention to provide a self-contained kit for producing a perfect bound book which can be sold as a single unit which includes the book-like cover portion and a supply of paper adapted for use in the kit.

It is a further objective of the invention to provide a self-contained kit for producing a perfect bound book which allows the user to select the desired number of pages for the album.

It is yet a further objective of the invention to provide a user with a novel method for assembling a perfect bound book from a user's own material.

In accordance with the above objectives, a do-it-yourself kit for constructing a perfect bound book is provided having a rigid book-like cover and a supply of paper which fits within the cover and is adapted for use in the kit. The paper can be ink jet printer paper or photographic paper. The book-like cover has a front cover panel and a rear cover panel and a spine therebetween wherein the spine has a length and the front cover panel and the rear cover panel are hingedly attached to the spine along the length. The spine includes a central elongated panel and adjoining hingedly connected left and right elongated panels wherein the spine is positionable between a flat configuration and a U-shaped configuration. The left and right elongated panels each have inside surfaces which include adhesive regions covered with removable strips. The adhesive regions can consist of double sided tape or an adhesive coating. Each of the sheets of paper has an inside edge and an adhesive region adjacent to the inside edge which is covered with a removable strip prior to assembly. The adhesive region can be an adhesive coating. In accordance with the principles of the invention, images can be printed on the plurality of sheets of paper, and the plurality of sheets of paper can be adhered to the left and right elongated panels of the spine and one another in a substantially coextensive configuration to form a book. The images can be printed by any suitable means, including a printer coupled to a personal computer, a color copier, or a digital printing press.

The method for constructing a photo album comprises providing a rigid book-like cover having a front cover panel and a rear cover panel and a spine therebetween. The front cover panel and the rear cover panel are hingedly attached to the spine. The spine includes a central elongated panel and adjoining hingedly connected left and right elongated panels and is positionable between a flat configuration and a U-shaped configuration. The left and right elongated panels each have inside surfaces which include adhesive regions covered with removable strips.

A plurality of sheets of paper are sized to fit within the book-like cover, each of the sheets of paper having an inside edge to be positioned along the spine and an adhesive region adjacent to the inside edge and a removable strip covering the adhesive region.

Images are printed on a portion of the paper, and the sheets of paper are affixed to one another in a coextensive configuration by removing the removable strips from the paper and engaging the adhesive regions to form a booklet having a bound left edge. The left edge of the booklet is affixed to the adhesive strips on the left and right elongated panels so that the booklet is substantially coextensive with the front cover panel and the rear cover panel to form a book. A paper cover sheet adapted to partially wrap around the book-like cover having a width equal to the length of the spine can also be provided.

### BRIEF DESCRIPTION OF THE FIGURES

FIG. 1 illustrates the elements of the kit for producing a perfect bound book according to a preferred embodiment of the present invention, namely a book-like cover portion and a plurality of sheets of paper adapted for use in the kit of the invention;

FIG. 2 is a bottom plan view showing the interior surfaces of the cover portion shown in FIG. 1, with the cover portion shown in an unassembled flat configuration;

FIG. 3 is a bottom end view of the cover portion shown in FIG. 1, in which the cover is shown in a folded configuration;

FIG. 4 illustrates the adhesive region on a sheet of paper according to the preferred embodiment of the invention; and

FIGS. 5a-h illustrate the steps of assembling the perfect bound book of the invention.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

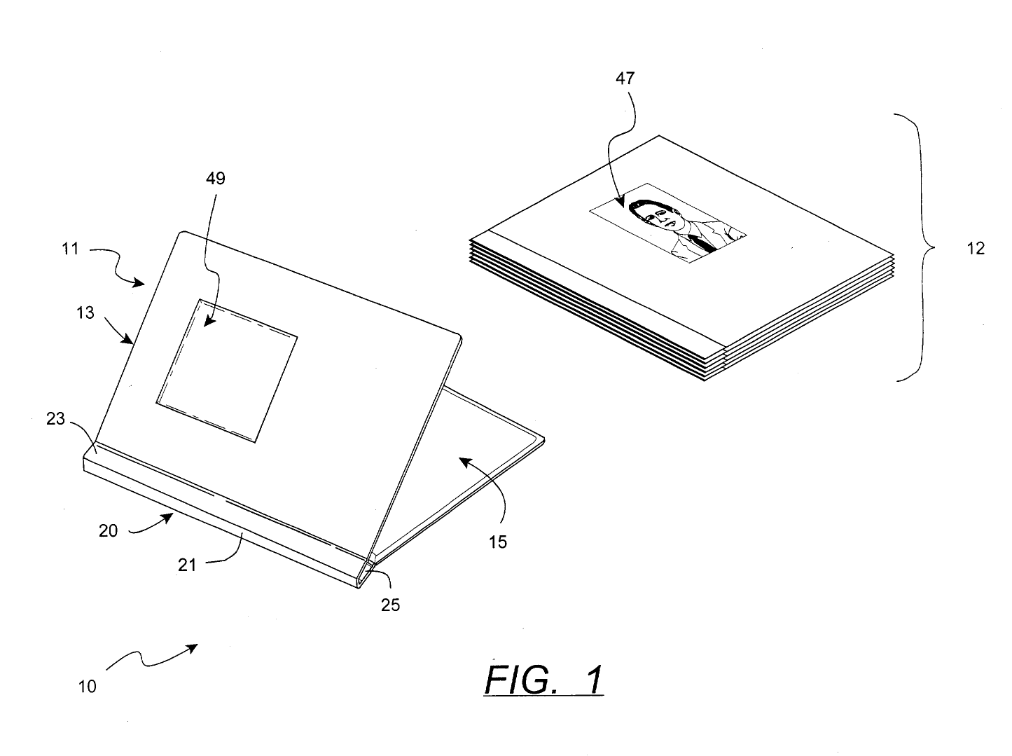

FIG. 1 illustrates the elements of the kit 10 of the invention. The kit 10 includes a rigid book-like cover 11 and a plurality of sheets of paper 12. The paper 12 is of a type of paper which can reproduce high quality photographic images from a digital source. Suitable types of paper would include ink jet printer paper or lightweight photographic paper. The paper 12 is sized to fit within the cover to create a perfect bound book. In the practice of the invention, images (as represented in the illustration by image 47) are printed onto the paper 12 using a printer coupled to a personal computer, a color copier, a digital printing press or any other suitable means to transfer digital images to the paper 12. The paper 12 includes an adhesive for assembling the perfect bound book, as will be discussed in detail hereinafter. Images can be printed on one or both sides of the paper.

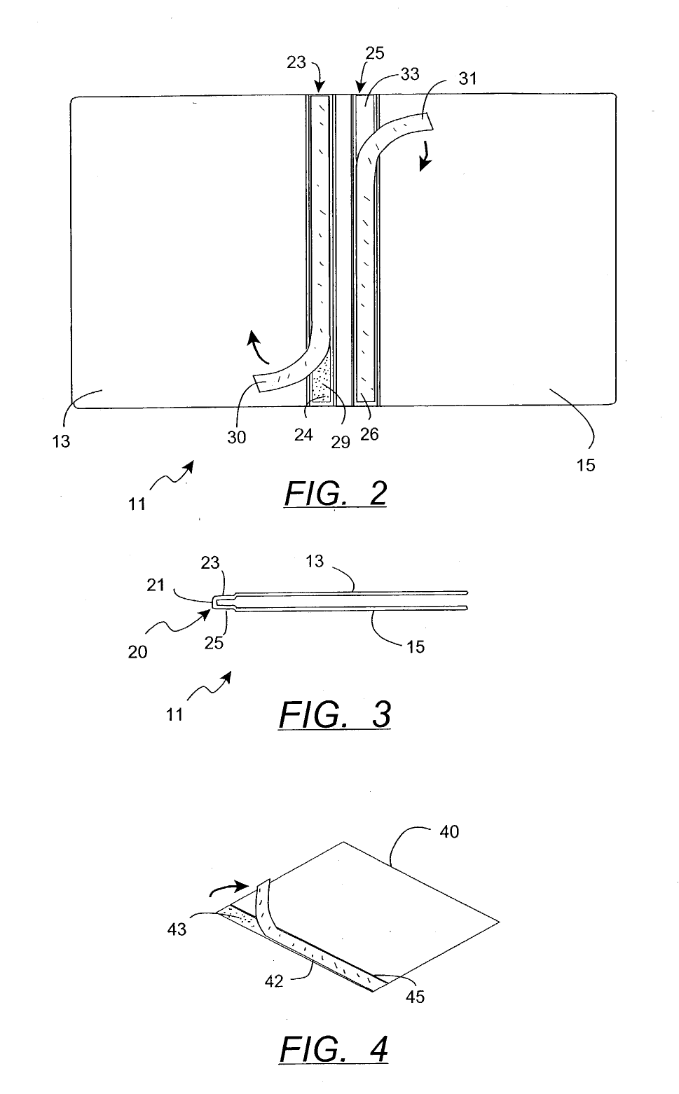

The cover 11 includes a front cover panel 13 and a rear cover panel 15 hingedly attached to a spine 20 positioned therebetween. The spine 20 includes central elongated panel 21 positioned between and hingedly adjoined to a left side elongated panel 23 and a right side elongated panel 25. The hinged arrangement of the spine 20 allows the spine 20 to be positioned between a flat configuration (when the cover 11 is fully opened, as shown in FIG. 2) and a U-shaped configuration (when the cover 11 is closed, as shown in FIG. 3). The kit 10 of the invention can be provided with varying sizes of the cover 11 and sheets of paper, i.e. with spines of varying widths to create the desired book thickness, and with front and rear panels of varying dimensions to accommodate different paper sizes.

The front cover panel 13 can include a recess 49 which can receive a label (not shown). The recess 49 can have any desired shape or position on the front cover. The kit of the invention can include printable labels, such as adhesive-backed labels, which can inserted into the recess 49. The recess 49 preferably has a depth approximately equal to that of the label so that the label will be flushly aligned with the surface.

Referring now to an inside view of the cover 11 shown in FIG. 2, it is seen that the left side elongated panel 23 and right side elongated panel 25 respectively includes inside surfaces 24 and 26. The inside surfaces 24 and 26 each include adhesive regions 20 and 33. The adhesive regions are initially covered with removable strips 30 and 31, shown partially peeled away in FIG. 2. In a preferred embodiment, the adhesive regions are formed from a high tack double-sided tape, such as 415 tape manufactured by the Minnesota Mining and Manufacturing Company, St. Paul, Minn. A suitable adhesive can also be applied directly to the inside surfaces 24 and 26. The adhesive preferably has a cohesive strength which can provide a permanent bond to the paper 12.

FIG. 4 illustrates the construction of a single sheet of paper 40 as is used in the kit 10. Each sheet of paper 40 has an inside edge 42, with the term “inside edge” as used herein being defined as the edge which is adjacent to the spine 20 when the paper 12 is inserted into the cover 11. Each sheet of paper 40 includes adhesive region 43 in the form of an adhesive coating on one side which is adjacent to the inside edge 42. The adhesive region 43 is covered with a removable strip 44 prior to assembly. In the practice of the invention, the removable strip 44 should be sufficiently adhered to the adhesive region 43 so as to stay intact when the sheet of paper 40 is fed through a printer or copier. Each sheet of paper 40 can include a score line 45 adjacent to the adhesive region 43. In the preferred embodiment, the paper 40 is ink jet paper or photographic paper, however the invention is not limited in this regard. Other types of paper can be utilized in the kit of the invention, such as art paper, simulated water color paper, canvas, or the like.

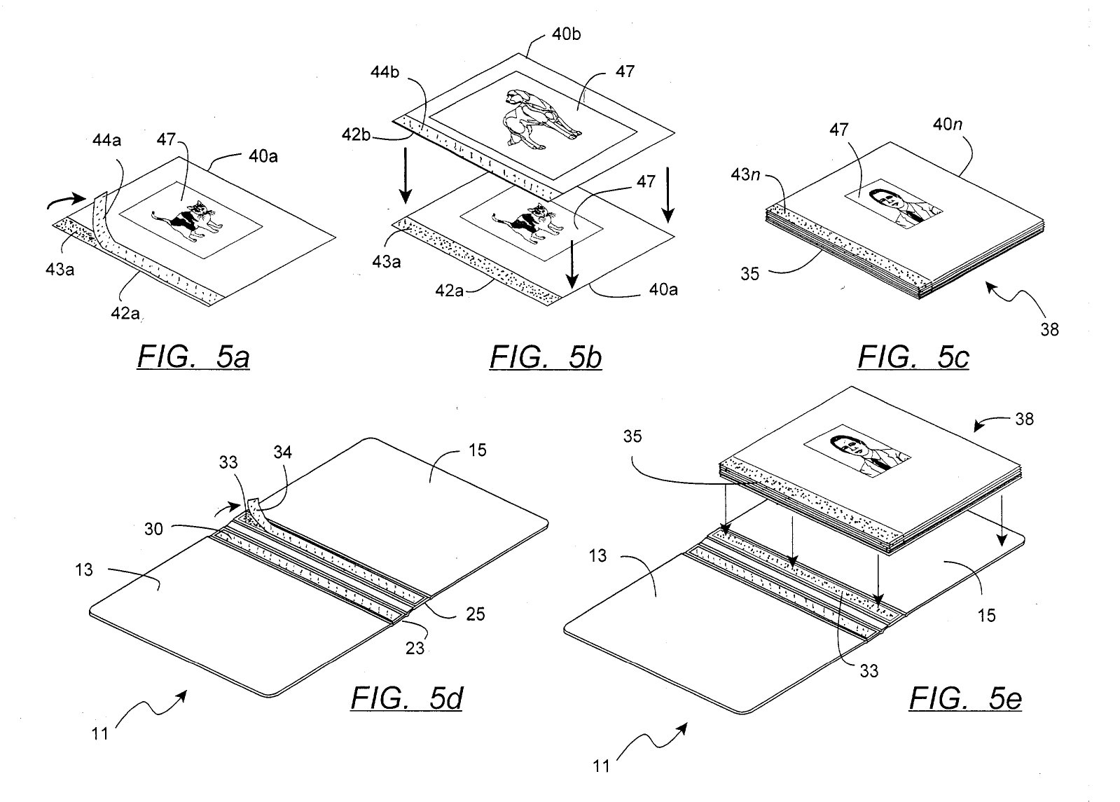

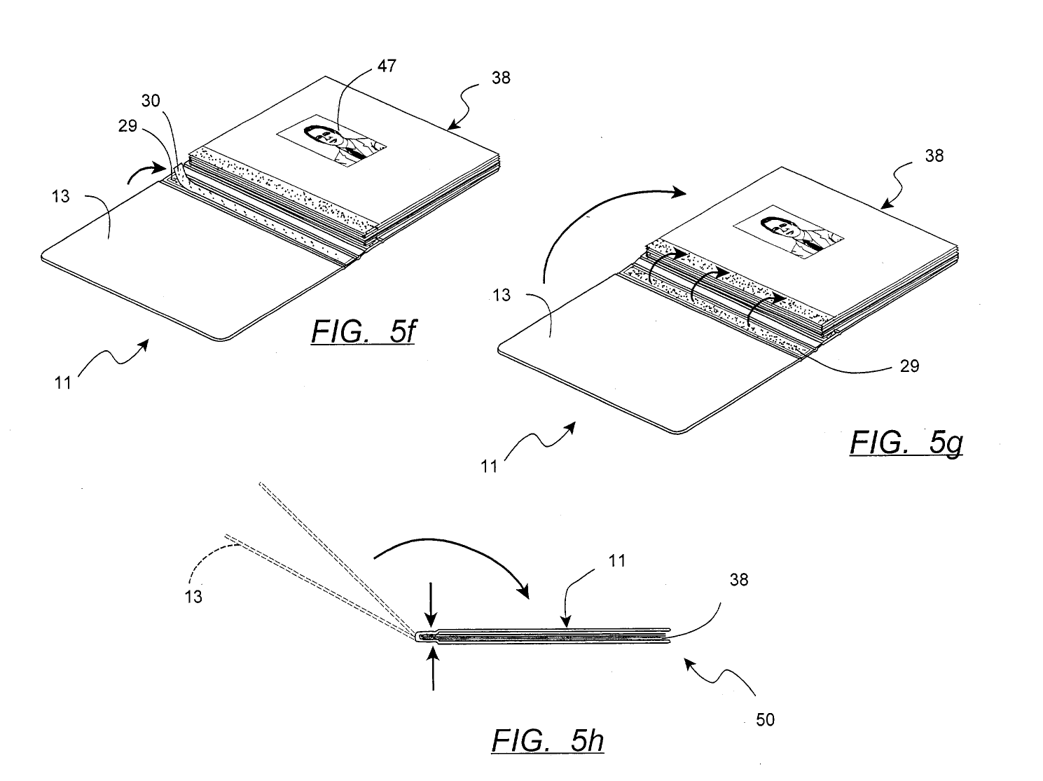

FIGS. 5a-h illustrate the steps in the assembly of the perfect bound book in accordance with the principles of the invention. The illustrated steps are meant to be only a typical method of assembly, it being understood that any desired sequence of steps can be used to create the final product. Prior to assembly, images (represented as example images 47) are printed on each of the plurality of sheets of paper 12. The term “images,” as used herein, refers to collectively to text matter, graphics, photographs, and any other miscellaneous indicia which can be printed or otherwise rendered in “hard copy” form. This can be accomplished with a printer coupled to a personal computer, or a color copier, a digital printing press or any other suitable means to transfer the desired images to the paper 12. Images 47 can be printed on one or both sides of the sheets of paper 12. In addition, the pages of the book can contain hand-rendered material, such as original artwork in any suitable medium. The pages can also include hand-assembled media, such as collages.

As shown in FIG. 5a, the removable strip 44a is removed from a sheet of paper 40a to expose the adhesive region 43a. In FIG. 5b, a second sheet of paper 40b is aligned with the sheet of paper 40a and positioned so that the inside edges 42a and 42b are in alignment. The sheets of paper 40a and 40b can then be adhered to one another by applying pressure over the adhesive region 43a. The kit of the invention can further include an alignment aid (not shown), such as a right angle shaped implement, to enable the user to correctly align the pages. This process is repeated with subsequent sheets of paper until the sheet of paper 40n is adhered in place, thus creating a booklet 38 (FIG. 5c). The inside edges 42 of the sheets of paper are aligned to create a bound left edge 35 on booklet 38. At this point, the adhesive strip 44n (not shown) is removed to expose adhesive region 43n. This example illustrates the images 47 being printed on the side of the sheets of paper 40 containing the adhesive region 43, however it will be understood that images could also be printed on the opposite side, with the booklet 38 being assembled using steps in reverse of the illustrated steps (i.e. from front to back, instead of from back to front as shown.) The score lines 45 in the individual sheets of paper 40 serve to facilitate the turning of the pages in the booklet 38.

In FIG. 5d, the removable strip 34 is peeled away to expose the adhesive region 33 on the right side elongated panel 25. The booklet 38 is then aligned with the rear cover panel 15 so as to be substantially coextensive with the rear cover panel 15 with the left edge 35 adjacent to the adhesive region 33. The booklet 38 is then affixed to the cover 11 by applying sufficient pressure to engage the adhesive region 33 with the booklet 38. In FIG. 5f, the removable strip 30 is peeled away to expose the adhesive region 29 on the left side elongated panel 23. The front cover panel 13 can then be folded inward along spine 20 to be in alignment with rear cover panel 15 and coextensive with booklet 38. Pressure can then be applied to the left and right elongated panels 23, 25 to engage the adhesive region. The product thus formed is the perfect bound book 50. If desired, the kit 10 can also include decorative facing sheets which can be inserted between the cover 11 and the booklet 38.

The cover 11 can a decorative covering, such as cloth, leather, faux leather, etc. In an alternative embodiment of the kit of the invention, the cover 11 can be unfinished for the purpose of allowing custom-finishing by the consumer. For example, fabric or paper can be glued directly onto the cover 11. The kit can also include paper cover sheet adapted to partially wrap around the cover 11.

The invention contemplates the printing of images from digital files to create the pages of a perfect bound book, however any subject matter can be printed on the sheets of paper 12, such as text matter, graphic artwork, etc. It will be appreciated that a user can utilize the invention in combination with a personal computer, printer and software to create a custom perfect bound book from any type of printed matter. The kit and method of the invention are especially well suited for the creation of a custom photograph album in the form of a perfect bound book.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

I claim:

1. A kit for constructing a perfect bound book, comprising:
a rigid book-like cover having a front cover panel and a rear cover panel and a spine therebetween, said spine having a length, said front cover panel and said rear cover panel being hingedly attached to said spine along said length; said spine including a central elongated panel and adjoining hingedly connected left and right elongated panels wherein said spine is positionable between a flat configuration and a U-shaped configuration; said left and right elongated panels having a having an inside surface, said inside surfaces each including adhesive regions;
a plurality of sheets of paper sized to fit within said book-like cover, each of said sheets of paper having an inside edge and an adhesive region adjacent to said inside edge;
whereby images can be printed on said plurality of sheets of paper, and said plurality of sheets of paper can be adhered to said left and right elongated panels of said spine and one another in a substantially coextensive configuration to form a perfect bound book.

2. The kit of claim 1, wherein said adhesive regions on said left and right elongated panels are comprised of double-sided tape.

3. The kit of claim 1, wherein said adhesive region adjacent to said inside edge of said sheet of paper is covered with a removable strip.

4. The kit of claim 1, wherein said adhesive regions on said inside surfaces of said left and right elongated panels are covered with removable strips.

5. The kit of claim 1, wherein each of said plurality of sheets of paper includes a score line adjacent to said adhesive region.

6. The kit of claim 1, wherein said adhesive regions on said left and right elongated panels have an adhesive coating.

7. The kit of claim 1, wherein said adhesive region adjacent to said inside edge of said paper has an adhesive coating.

8. The kit of claim 1, further including a paper cover sheet adapted to partially wrap around said book-like cover, wherein said paper cover sheet has a width equal to the length of said spine.

9. The kit of claim 1, wherein said paper is ink jet printer paper.

10. The kit of claim 1, wherein said paper is photographic paper.

11. A method for constructing a perfect bound book, comprising:
providing a rigid book-like cover having a front cover panel and a rear cover panel and a spine therebetween wherein the front cover panel and the rear cover panel are hingedly attached to the spine; the spine including a central elongated panel and adjoining hingedly connected left and right elongated panels wherein the spine is positionable between a flat configuration and a U-shaped configuration, the left and right elongated panels having a having an inside surface wherein the inside surfaces each include adhesive regions covered with removable adhesive cover strips;
providing a plurality of sheets of paper sized to fit within the book-like cover, each of the sheets of paper having an inside edge to be positioned along the spine and an adhesive region adjacent to the inside edge and a removable adhesive cover strip covering the adhesive region;
printing images on a portion of the plurality of sheets of paper;
affixing the portion of the plurality of sheets of paper to one another in a coextensive configuration by removing the removable strips from the sheets of paper and engaging the adhesive regions to form a booklet having a bound left edge;
removing the adhesive cover strips from the adhesive regions on the left and right elongated panels; and
affixing the left edge of the booklet to the adhesive strips on the left and right elongated panels so that the booklet is substantially coextensive with the front cover panel and the rear cover panel to form a book.

12. The method of claim 11, wherein the images are printed by a printer coupled to a personal computer.

13. The method of claim 11, wherein the images are printed by a color copier.

14. The method of claim 11, wherein the images are printed by a digital printing press.

15. The method of claim 11, wherein the paper is ink jet printer paper.

16. The method of claim 11, wherein the paper is photographic paper.

17. The method of claim 11, further comprising the steps of:
providing a paper cover sheet adapted to partially wrap around the book-like cover, wherein the paper cover sheet is has a width equal to the length of the spine.

18. The method of claim 17, further comprising the step of printing images on the paper cover sheet.

19. A method for constructing a photograph album, comprising:
providing a rigid book-like cover having a front cover panel and a rear cover panel and a spine therebetween wherein the front cover panel and the rear cover panel are hingedly attached to the spine; the spine including a central elongated panel and adjoining hingedly connected left and right elongated panels wherein the spine is positionable between a flat configuration and a U-shaped configuration, the left and right elongated panels having a having an inside surface wherein the inside surfaces each include adhesive regions covered with removable adhesive cover strips;
providing a plurality of sheets of paper sized to fit within the book-like cover, each of the sheets of paper having an inside edge to be positioned along the spine and an adhesive region adjacent to the inside edge and a removable adhesive cover strip covering the adhesive region;
printing photographs on a portion of the plurality of sheets of paper;
affixing the portion of the plurality of sheets of paper to one another in a coextensive configuration by removing the removable strips from the sheets of paper and engaging the adhesive regions to form a booklet having a bound left edge;
removing the adhesive cover strips from the adhesive regions on the left and right elongated panels; and
affixing the left edge of the booklet to the adhesive strips on the left and right elongated panels so that the booklet is substantially coextensive with the front cover panel and the rear cover panel to form a book.
